(19) United States
(12) Patent Application Publication
(10) Pub. No.: US 2005/0014874 A1
(43) Pub. Date: Jan. 20, 2005

(54) Flame-retardant polyamides

(75) Inventors: Sebastian Hoerold, Diedorf (DE); Wolfgang Wanzke, Augsburg (DE); Ottmar Schacker, Gersthofen (DE); Elke Schlosser, Augsburg (DE)

Correspondence Address: Clariant Corporation;Industrial Property Department, 4000 Monroe Road, Charlotte, NC, 28205, US

(73) Assignee: Clariant GmbH

(21) Appl. No.: 10/890,366

(22) Filed: Jul. 13, 2004

(30) Foreign Application Priority Data
Jul. 14, 2003 (DE) 103 31 889.5

(51) Int. Cl. C08K 5/34; C08K 5/53

(52) U.S. Cl. 524/126; 524/133

(57) ABSTRACT

The invention relates to flame-retardant aromatic or semiaromatic copolyamides comprising, as flame retardant, at least one phosphinic salt of the formula (I), and/or one diphosphinic salt of the formula (II), and/or polymers of these, 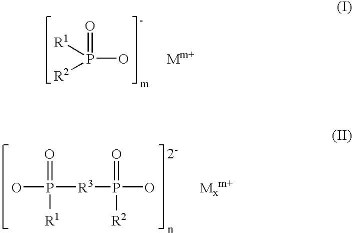 where
R¹, R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Zn, Fe, Zr, Ce, Bi, Sr, Mn, Li, Na; K and/or a protonated nitrogen base; m is from 1 to 4; n is from 1 to 4; x is from 1 to 4.

The present invention is described in the German priority application No. 10331889.5, filed 14.07.2003, which is hereby incorporated by reference as is fully disclosed herein.

The present invention relates to flame-retardant aromatic or semiaromatic copolyamides.

Salts of phosphinic acids (phosphinates) have proven to be effective flame-retardant additives for thermoplastic polymers (DE-A-2 252 258 and DE-A-2 447 727). Calcium phosphinates and aluminum phosphinates have been described as particularly effective in polyesters, and, when compared with the alkali metal salts, for example, give less impairment of the material properties of the polymeric molding compositions (EP-A-0 699 708). DE 196 07 635 describes calcium phosphinates and aluminum phosphinates as particularly effective flame retardants for polyamides. Polyamides are polymers whose polymer chain contains units repeating by way of an amide group.

Copolyamides are products prepared from more than one polyamide-forming monomer. The properties of the polyamides can be varied widely via the selection of the monomers and of the mixing ratio.

Certain copolyamides with aromatic monomers are technical products of greater interest than aliphatic copolyamides. They have a higher glass transition temperature and a higher melting point of the semicrystalline regions and therefore have adequate thermal stability for use in practical applications. For example, semicrystalline polyamides with high thermal stability can be prepared from terephthalic acid and/or isophthalic acid and polyamines, such as hexamethylenediamine.

Surprisingly, it has now been found that aluminum phosphinates and zinc phosphinates are considerably more effective flame retardants in semiaromatic polyamides than in aliphatic polyamides, such as nylon-6, nylon-6,6, or nylon 12.

Surprisingly, it has also been found that the high thermal stability of the semiaromatic polyamides is substantially retained after addition of the phosphinates, and that the phosphinate/polyamide mixtures can be processed at high temperatures without polymer degradation or discoloration.

Synergistic combinations of phosphinates with certain nitrogen-containing compounds have also been found, and these are more effective as flame retardants than the phosphinates alone in a very large number of polymers (WO 97/39053, and also DE-A-197 34 437 and DE-A-197 37 727).

Inter alia, melamine and melamine compounds have been described as effective synergists, examples being melamine cyanurate and melamine phosphate, which themselves also have some degree of flame-retardant action in certain thermoplastics, but are markedly more effective in combination with phosphinates.

Higher-molecular-weight derivatives of melamine, such as the condensates melam, melem, and melon, have been described as flame retardants, as also have appropriate reaction products of these compounds with phosphoric acid, i.e. dimelamine pyrophosphate and melamine polyphosphates. However, the amounts which have to be added within thermoplastics are relatively high, in particular in the case of glass-fiber-reinforced materials.

The invention therefore provides flame-retardant aromatic or semiaromatic copolyamides which comprise, as flame retardant, at least one phosphinic salt of the formula (I), and/or one diphosphinic salt of the formula (II), and/or polymers of these, 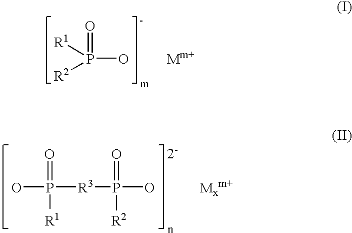
where
R¹, R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na; K and/or a protonated nitrogen base;
m is from 1 to 4;
n is from 1 to 4;
x is from 1 to 4.
M is preferably calcium, aluminum, or zinc.

Protonated nitrogen bases are preferably the protonated bases of ammonia, melamine, triethanolamine, and in particular NH₄⁺.

Preferred meanings of R¹ and R², identical or different, are C₁-C₆-alkyl, linear or branched, and/or phenyl.

Preferred meanings of R¹ and R², identical or different, are methyl, ethyl, n-propyl, isopropyl, n-butyl, tert-butyl, n-pentyl and/or phenyl.

Preferred meanings of R³ are methylene, ethylene, n-propylene, isopropylene, n-butylene, tert-butylene, n-pentylene, n-octylene or n-dodecylene.

Other preferred meanings of R³ are phenylene or naphthylene.

Other preferred meanings of R³ are methylphenylene, ethylphenylene, tert-butylphenylene, methylnaphthylene, ethylnaphthylene or tert-butylnaphthylene.

Other preferred meanings of R³ are phenylmethylene, phenylethylene, phenylpropylene or phenylbutylene.

The inventive copolyamide may preferably comprise, as further component B, a nitrogen compound, phosphorus compound, or phosphorus-nitrogen compound.

Component B preferably comprises melamine phosphate, dimelamine phosphate, melamine pyrophosphate, melamine polyphosphates, melam polyphosphates, melem polyphosphates, and/or melon polyphosphates.

The inventive copolyamide preferably comprises at least one nitrogen compound as further component B.

The nitrogen compounds are preferably compounds of the formulae (III) to (VIII), or a mixture of these, 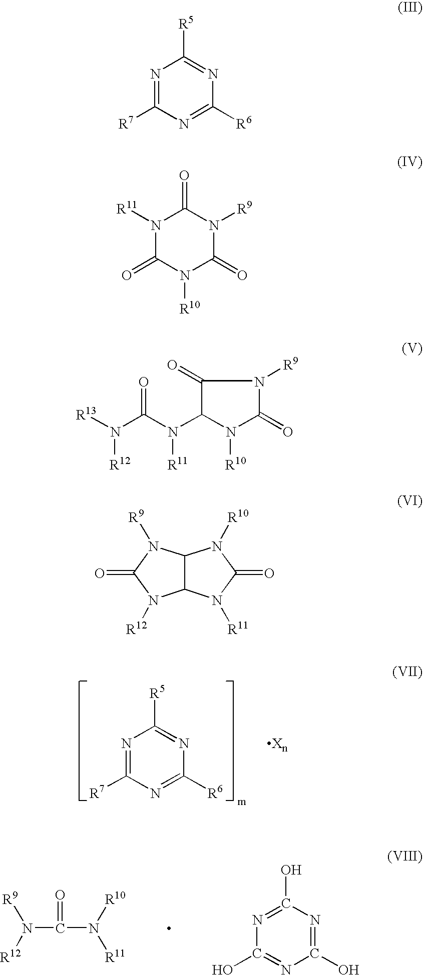
where
R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, or else a system of N-alicyclic or N-aromatic nature,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy or C₆-C₁₂-aryl or -arylalkyl,
R⁹ to R¹³ are the same as the groups for R⁸, or else —O—R⁸,
m and n, independently of one another, are 1, 2, 3 or 4,
X is acids which can form adducts with triazine compounds (III).

The inventive copolyamide preferably comprises, as component B, oligomeric esters of tris(hydroxyethyl) isocyanurate with aromatic polycarboxylic acids, or comprises benzoguanamine, tris(hydroxyethyl) isocyanurate, allantoin, glycoluril, melamine, melamine cyanurate, dicyandiamide, guanidine, and/or carbodiimides.

The inventive copolyamide preferably comprises, as component B, nitrogen-containing phosphates of the formulae (NH₄)_{y} H_{3-y} PO₄ or (NH₄ PO₃)_{z}, where y is from 1 to 3 and z is from 1 to 10 000.

The inventive copolyamide preferably comprises, as component C, a synthetic inorganic compound, and/or a mineral product.

Component C preferably comprises an oxygen compound of silicon, magnesium compounds, metal carbonates of metals of the second main group of the Periodic Table, red phosphorus, zinc compounds, or aluminum compounds.

The oxygen compounds of silicon preferably comprise salts and esters of orthosilicic acid and condensates thereof, silicates, zeolites, and silicas, glass powder, glass-ceramic powder, or ceramic powder; the magnesium compounds comprise magnesium hydroxide, hydrotalcites, magnesium carbonates, or magnesium calcium carbonates; the zinc compounds comprise zinc oxide, zinc stannate, zinc hydroxystannate, zinc phosphate, zinc borate, or zinc sulfides; the aluminum compounds comprise aluminum hydroxide or aluminum phosphate.

The inventive copolyamide preferably comprises from 2 to 30% by weight of component A and from 0 to 30% by weight of component B.

The inventive copolyamide preferably comprises from 10 to 25% by weight of component A, from 0 to 20% by weight of component B, and from 0 to 10% by weight of component C.

The inventive copolyamide preferably comprises from 10 to 20% by weight of component A, from 0 to 10% by weight of component B, and from 0 to 5% by weight of component C.

The copolyamides preferably comprise polyamides which contain, as aromatic dicarboxylic acid, terephthalic acid or isophthalic acid. The semiaromatic copolyamides preferably comprise polyamides which contain, as aromatic diamines, phenylenediamines or xylylenediamines.

Inventive aromatic or semiaromatic copolyamides are described by way of example in Becker/Braun Kunststoff Handbuch [Plastics handbook] ¾ Polyamide [Polyamides], edited by L. Bottenbruch and R. Binsack, chapter 6, teilaromatische und aromatische Polyamide [Semiaromatic and aromatic polyamides], pp. 803-845 expressly incorporated herein by way of reference.

Inventive aromatic or semiaromatic copolyamides may also comprise block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol, or else EPDM- or ABS-modified polyamides or copolyamides; or else polyamides condensed during processing (“IM polyamide systems”).

The expression “phosphinic salt” hereinafter encompasses salts of phosphinic and of diphosphinic acids, and polymers of these.

The phosphinic salts, prepared in an aqueous medium, are in essence monomeric compounds. Depending on the reaction conditions, polymeric phosphinic salts may also be produced in some circumstances.

Examples of phosphinic acids which are a suitable constituent of the phosphinic salts are:
dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid and diphenylphosphinic acid.

The inventive salts of the phosphinic acids may be prepared by known methods, for example those described in more detail in EP-A-0 699 708. By way of example, the phosphinic acids here are reacted in aqueous solution with metal carbonates, metal hydroxides, or metal oxides.

The amount of the phosphinic salt to be added to the polymers may vary widely. Use is generally made of from 1 to 50% by weight, based on the plastics molding composition. The ideal amount depends on the nature of the polymer and on the nature of components B, and on the type of the actual phosphinic salt used. Preference is given to from 3 to 40% by weight, in particular from 5 to 30% by weight, based on the plastics molding composition.

The abovementioned phosphinic salts may be used in various physical forms for the inventive flame-retardant combination, depending on the nature of the polymer used and on the desired properties. For example, the phosphinic salts may be ground to give a fine-particle form in order to achieve better dispersion in the polymer. If desired, it is also possible to use mixtures of various phosphinic salts.

The phosphinic salts used according to the invention in the flame-retardant combination are thermally stable, and neither decompose the polymers during processing, nor affect the preparation process for the plastics molding composition. The phosphinic salts are non-volatile under the usual conditions of preparation and processing for thermoplastic polymers.

The flame-retardant components A, and also, where appropriate, B and C may be incorporated into semiaromatic copolyamides by, for example, premixing all of the constituents in the form of powders and/or pellets in a mixer, and then homogenizing them in the polymer melt in a compounding assembly (e.g. a twin-screw extruder). The melt is usually drawn off in the form of an extrudate, cooled and pelletized. Components A, and also, where appropriate, B and C may also be separately introduced directly into the compounding assembly by way of a metering system.

It is also possible to admix the flame-retardant components A, and also, where appropriate, B and C with ready-to-use polymer pellets or ready-to-use polymer powder, and process the mixture directly in an injection-molding machine to give moldings.

Alongside the inventive flame-retardant combination composed of A, and also, where appropriate, B and C, the semiaromatic copolyamides may also receive additions of fillers and reinforcing materials, such as glass fibers, glass beads, or minerals, such as chalk. In addition, other additives may also be present in the polyamides, examples being antioxidants, light stabilizers, lubricants, colorants, nucleating agents, or antistatic agents. Examples of the additives which may be used are given in EP-A-0 584 567.

The inventive semiaromatic copolyamides are suitable for producing moldings, films, filaments, or fibers, for example via injection molding, extrusion, or pressing.

Fire protection for electrical and electronic equipment has been specified in specifications and standards for product safety. In the USA, fire-protection testing and fire-protection approval procedures are carried out by Underwriters Laboratories (UL). The UL specifications are nowadays accepted worldwide. Fire tests for plastics were developed in order to determine the resistance of the materials to ignition and flame spread.

Depending on fire-protection requirements, the materials have to pass horizontal combustion tests (UL 94 HB), or the more stringent vertical tests (UL 94 V-2, V-1, or V-0). These tests simulate low-energy ignition sources which occur in electrical devices, and to which plastics parts of electrical modules can be exposed.

### EXAMPLES

1. Components Used

Commercially available polymers (pellets):
Nylon-6,6:®Durethan A 30 (Bayer AG, Germany)
Nylon-6 ®Durethan B 29 (Bayer AG, Germany)

Semiaromatic polyamides:
®Durethan T 40 (Bayer AG, Germany): polyamide composed of isophthalic acid and 1,6-diaminohexane
®Ultramid T (BASF AG, D): polyamide composed of terephthalic acid, diaminohexane, and caprolactam
Amodel (Solvay, USA): polyamide composed of terephthalic acid, isophthalic acid, adipic acid, and diaminohexane
Zytel HTN (DuPont, USA): polyamide composed of terephthalic acid, diaminohexane, 2-methyldiaminopentane

Flame retardant components (pulverulent):

Aluminum diethylphosphinate, hereinafter termed DEPAL.

2. Preparation, Processing and Testing of Flame-Retardant Plastics Molding Compositions

The polymers were processed on a twin-screw extruder (Leistritz ZSE 25/44) at temperatures of from 260 to 280° C. (GRPA 6.6) or from 230 to 250° C. (GRPA 6) or 300-320° C. (semiaromatic copolyamides). The homogenized polymer strand was drawn off, cooled in a waterbath, and then pelletized.

The flame retardant components were mixed in the ratio stated in the tables, and added to the polymer melt by way of a side feed. The glass fibers were likewise added by way of a side feed.

After adequate drying, the molding compositions were processed in an injection-molding machine (Arburg 320 C Allrounder) to give test specimens, and tested and classified for flame retardancy on the basis of the UL 94 (Underwriters Laboratories) test and the glow-wire test to IEC 60695-2.

The flowability of the molding compositions was determined via determination of the melt volume index (MVR) at 275° C. with 2.16 kg. A sharp rise in the MVR value indicates polymer degradation.

Unless otherwise stated, all of the tests in each series were carried out under identical conditions (temperature profiles, screw geometries, injection-molding parameters, etc.), for reasons of comparability.

Table 1 shows comparative examples in which Depal was used in nylon-6,6 or nylon-6.

The results of the examples in which the inventive phosphinates were used in semiaromatic copolyamides are listed in Table 2. All of the amounts are stated as % by weight and are based on the plastics molding composition inclusive of the flame retardant combination and of additives.

Surprisingly, the examples show that Depal is markedly more effective in semiaromatic copolyamides than in nylon-6,6 or nylon-6. V-0 classification is not achieved in nylon-6 or nylon-6,6 until the addition rate has reached 30% of Depal, and at 20% of Depal the afterflame times are too long, and flaming drops are also observed. In contrast, in the semiaromatic copolyamides a feed rate as low as 20% achieves V-0 classification. The lower content of flame retardant gives better mechanical properties. Glass contents can also be set higher. Despite the high processing temperatures of >300° C., no discoloration or polymer degradation is observed.

Unless otherwise stated, all amounts are given in % by weight.

TABLE 1
Comparative examples: Depal as flame retardant in
glass-fiber-reinforced PA 6.6 and PA 6

| Comparative | 30% GF | DEPAL | UL 94 classification |
|---|---|---|---|
| examples | polyamide | [%] | (0.8 mm) |
| 1 | PA 66 | 0 | n.c.*⁾ |
| 2 | PA 66 | 10 | n.c. |
| 3 | PA 66 | 20 | V-2 |
| 4 | PA 66 | 30 | V-0 |
| 5 | PA 6 | 10 | n.c. |
| 6 | PA 6 | 20 | n.c. |
| 7 | PA 6 | 30 | V-0 |

*⁾n.c. = not classifiable

TABLE 2
Inventive examples: Depal in glass-fiber-reinforced semiaromatic
copolyamides

| Comparative | | DEPAL | UL 94 classification |
|---|---|---|---|
| examples | 30% GF polyamide | [%] | (0.8 mm) |
| 1 | Zytel HTN | 0 | n.c.*⁾ |
| 2 | Zytel HTN | 10 | n.c. |
| 3 | Zytel HTN | 20 | V-0 |
| 4 | Durethan T 40 | 0 | n.c. |
| 5 | Durethan T 40 | 10 | n.c. |
| 6 | Durethan T 40 | 20 | V-0 |
| 7 | Amodel | 10 | n.c. |
| 8 | Amodel | 20 | V-0 |

1. A flame-retardant aromatic or semiaromatic copolyamide comprising an aromatic or semiaromatic copolyamide and, as flame retardant (component A), at least one phosphinic salt of the formula (I), diphosphinic salt of the formula (II), a polymer of the phosphinic salt, a polymer of the diphosphinic salt, or mixtures thereof, 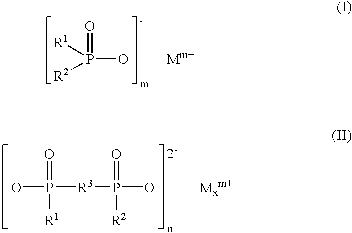
where
R¹, R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na; K or a protonated nitrogen base;
m is from 1 to 4;
n is from 1 to 4;
x is from 1 to 4.

2. The flame-retardant aromatic or semiaromatic copolyamide as claimed in claim 1, wherein R¹ and R² are identical or different, and are C₁-C₆-alkyl, linear or branched, or phenyl.

3. The flame-retardant aromatic or semiaromatic copolyamide as claimed in claim 1, wherein R¹ and R² are identical or different and are methyl, ethyl, n-propyl, isopropyl, n-butyl, tert-butyl, n-pentyl, or phenyl.

4. The flame-retardant aromatic or semiaromatic copolyamide as claimed in claim 1, wherein R³ is methylene, ethylene, n-propylene, isopropylene, n-butylene, tert-butylene, n-pentylene, n-octylene, n-dodecylene, phenylene, enaphthylene, methylphenylene, ethylphenylene, tert-butylphenylene, methylnaphthylene, ethylnaphthylene, tert-butylnaphthylene, phenylmethylene, phenylethylene, phenylpropylene, or phenylbutylene.

5. The flame-retardant aromatic or semiaromatic copolyamide as claimed in claim 1, wherein the copolyamide contains, as aromatic dicarboxylic acid, terephthalic acid or isophthalic acid.

6. The flame-retardant aromatic or semiaromatic copolyamide as claimed in claim 1, wherein the copolyamide contains, as aromatic diamines, phenylenediamines or xylylenediamines.

7. The flame-retardant aromatic or semiaromatic copolyamide as claimed in claim 1, further comprising component B selected from the group consisting of, a nitrogen compound, phosphorus compound, and a phosphorus-nitrogen compound.

8. The flame-retardant aromatic or semiaromatic copolyamide as claimed in claim 1, further comprising component B selected from the group consisting of melamine phosphate, dimelamine phosphate, melamine pyrophosphate, melamine polyphosphates, melam polyphosphates, melem polyphosphates, and melon polyphosphates.

9. The flame-retardant aromatic or semiaromatic copolyamide as claimed in claim 1, further comprising component B, wherein component B is a melamine condensate.

10. The flame-retardant aromatic or semiaromatic copolyamide as claimed in claim 1 further comprising component B, wherein component B is a nitrogen compound of the formulae (III) to (VIII), or a mixture of these, 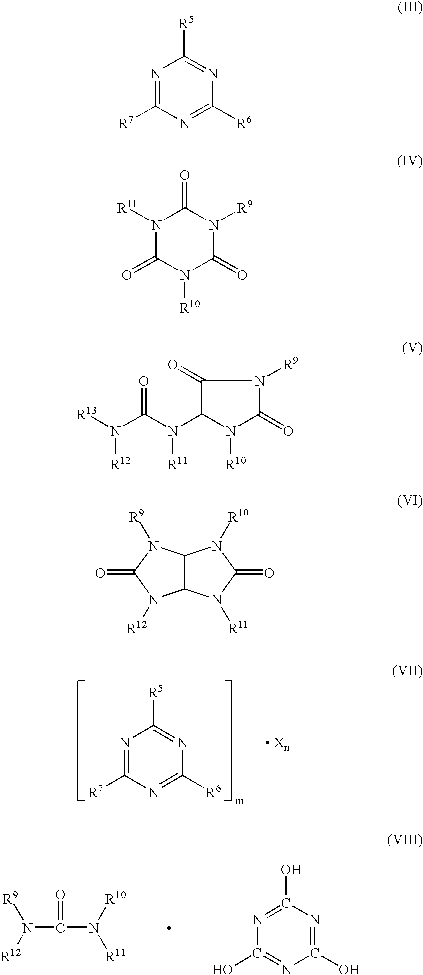
where
R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, —N(R⁸)R⁹, or a system of N-alicyclic or N-aromatic nature,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl,
R⁹ to R¹³ are the same as the groups for R⁸, or —O—R⁸,
m and n, independently of one another, are 1, 2, 3 or 4,
X is an acid which forms adducts with triazine compounds (III).

11. The flame-retardant aromatic or semiaromatic copolyamide as claimed in claim 1, further comprising component B selected from the group consisting of oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, guanidine, and carbodiimides.

12. The flame-retardant aromatic or semiaromatic copolyamide as claimed in claim 1, further comprising component B, wherein component B is a nitrogen-containing phosphate of the formulae (NH₄)_{y} H_{3-y} PO₄ or (NH₄ PO₃)_{z}, where y is from 1 to 3 and z is from 1 to 10 000.

13. The flame-retardant aromatic or semiaromatic copolyamide as claimed in claim 1, further comprising component C selected from the group consisting of a synthetic inorganic compound and a mineral product.

14. The flame-retardant aromatic or semiaromatic copolyamide as claimed in claim 1, further comprising component C selected from the group consisting of an oxygen compound of silicon, magnesium compounds, metal carbonates of metals of the second main group of the Periodic Table, red phosphorus, zinc compounds, and aluminum compounds.

15. The flame-retardant aromatic or semiaromatic copolyamide as claimed in claim 14, wherein the oxygen compounds of silicon are selected from the group consisting of salts and esters of orthosilicic acid and condensates thereof, silicates, zeolites, and silicas, glass powder, glass-ceramic powder and ceramic powder, wherein the magnesium compounds are selected from the group consisting of magnesium hydroxide, hydrotalcites, magnesium carbonates, magnesium calcium carbonates, wherein the zinc compounds are selected from the group consisting of zinc oxide, zinc stannate, zinc hydroxystannate, zinc stearate, zinc phosphate, zinc borate, and zinc sulfides, and wherein the aluminum compounds are selected from the group consisting of aluminum hydroxide and aluminum phosphate.

16. The flame-retardant aromatic or semiaromatic copolyamide as claimed in claim 7, further comprising from 2 to 30% by weight of component A and from 0 to 30% by weight of component B.

17. The flame-retardant aromatic or semiaromatic copolyamide as claimed in claim 7, further comprising from 10 to 25% by weight of component A, from 0 to 20% by weight of component B, and from 0 to 10% by weight of component C, wherein component C is selected from the group consisting of a synthetic inorganic compound and a mineral product.

18. The flame-retardant aromatic or semiaromatic copolyamide as claimed in claim 7, further comprising from 10 to 20% by weight of component A, from 0 to 10% by weight of component B, and from 0 to 5% by weight of component C, wherein component C is selected from the group consisting of a synthetic inorganic compound and a mineral product.

19. A polymer composition comprising a flame retardant aromatic or semiaromatic copolyamide according to claim 1.
